(19) United States
(12) Patent Application Publication
(10) Pub. No.: US 2011/0026690 A1
(43) Pub. Date: Feb. 3, 2011

(54) METHOD OF INFORMING A PERSON OF AN EVENT AND METHOD OF RECEIVING INFORMATION ABOUT AN EVENT, A RELATED COMPUTING

(76) Inventor: Marta Garcia Gomar, Madrid (ES)

Correspondence Address: Brian R. Galvin, P.O. BOX 2360, SILVERDALE, WA, 98383-2360, US

(21) Appl. No.: 12/736,437

(22) PCT Filed: Apr. 8, 2008
(86) PCT No.: PCT/EP2008/002778

§ 371 Date: Oct. 6, 2010

(51) Int. Cl. H04M 11/00; G10L 21/00

(52) U.S. Cl. 379/88.16; 704/270

(57) ABSTRACT

The invention refers to a Method of informing a person of an event comprising carrying out in a computing system the steps of: receiving (10) information of an event (1); determining (11) a specific person which is to be notified of the event (1); performing (12) an information action with the aim of informing the specific person of the event (1) via a telecommunications system; receiving (15) a voice utterance of a person; verifying (16) that the identity of the person coincides with that of the specific person based on the received voice utterance using biometric voice data.

The present invention relates to a method of informing a person of an event, to a method of receiving information about an event, to a computing system and to a computer readable medium.

In the prior art it is known, for example, to inform a specific person about a suspicious business bank account movement by an SMS (short message). In such cases, a person may phone the bank in order to enquire about the suspicious bank account movement or the like. In case however the person is not aware of the received SMS, for example, due to not having his mobile telephone at hand or his mobile phone being stolen, a person will not be aware of such notification.

In a case where it has to be made sure that a specific person receives information about a specific event such a method is not useful.

The present invention therefore refers to a way which ensures that it can be verified that a specific person receives information about an event.

This problem is solved by the method of claim 1, the method of claim 15, the computing system of claim 16 and the computer-readable medium of claim 17.

Preferred embodiments are disclosed in the dependent claims.

In a method of informing a person of an event, certain steps are carried out in a computing system. These steps comprise receiving information of an event, determining a certain person who is to be notified of the event, performing an informing action with the aim of informing the specific person of the event, receiving a voice utterance of a person and verifying that the identify of the person from which the voice utterance was received coincides with that of the specific person based on the received voice utterance.

In this method for a particular event a specific person is determined. This can be e.g. the bank account holder in the case of a suspicious bank account movement. The computing system then aims to contact the specific person and performs the required information action. A voice utterance from a person is received and it can then be verified that the identity of the person that is to be notified of the event coincides with the identity of the person from which the voice utterance was received. This verification here is based on the received voice utterance and thereby allows the use of biometric voice data which individually characterizes each person.

The received voice utterance is used during verification nor or not only based on the semantic content.

Characteristics of a persons individual voice are preferably taken into account. Such characteristics (biometric voice data) are dependent on the shape and size of a throat, mouth etc.

Biometric voice data may be data extracted from a frequency analysis of a voice. From a voice recording voice sequences of e. g. 20 or 30 ms may be Fourier-transformed and from the envelope thereof biometric voice data can be extracted. From a multiple of such Fourier-transformed voice sequences a statistical voice model can be generated, named Gaussian mixed model (GMM). However, any other biometric voice data that allow distinguishing one voice from another voice due to voice characteristics may be used.

Therefore, fraud in this case is made practically impossible since the voice of a person can hardly be falsified.

In this method the step of performing an information action may also be carried out after the step of verifying the identity. In this case the information of the event is only made available after having assured by the voice data, that the person of the voice utterance is the one that is supposed to be notified of the event. Preferably the information action is carried out by the same telecommunications system, by which the voice utterance was received. This assures that the person which provided the voice utterance is the one that receives the information of the event.

On the other hand it may be considered preferably to have the information action done before the voice utterance is received such that the voice utterance can be used to assure that the information action had success in informing the person of the event.

In the step of determining the specific person, the information received of the event can be used. If that event, for example, refers to a bank account movement, then a bank account number, a customer number, the name of the bank account holder or the like can be determined. This kind of information can then be related to data which are required for establishing contact with the specific person. This can be, for example, a telephone number of a landline telephone, telephone number of a mobile telephone or an IP address or any other suitable telecommunications identification.

The information action may comprise performing a (computer generated) telephone call, sending an SMS, email or instant messaging message, sending a letter to a postal address or sending a fax or any other communication means.

The performance of the telephone call, however, has the advantage that the voice utterance can be received directly by the specific telephone call. For other communication systems which do not allow speech communication, a separate communication connection allowing speech communication (at least in one direction) has to be set up. Such other communication systems, however, provide the advantage that the data communication does not have to be established in the same moment as it is attempted but a voice utterance can be received later than the information action.

In a preferred embodiment, the various options for the information action are conducted in a predefined order. -For example, a landline telephone connection is usually preferred to a mobile telephone connection and therefore, a call to a landline telephone is preferably executed before a phone call to a mobile telephone is tried. This is due to the fact that the noise background in a landline telephone communication is usually better than in the mobile telephone connection and therefore, the received voice utterance is of higher quality and can therefore be evaluated with more precision. Further the number of persons which may respond to the call is usually limited to the persons living in the location which corresponds to the landline connection.

Furthermore, a phone call is preferably executed at first to a home or a personal extension than to an office extension since background noise is expected to be less in such cases.

In the method, it is preferred that information regarding a desired voice utterance is transmitted. This information may be a text which has text portions such as words, numbers or letters or combinations thereof.

Here it is in particular preferred to have random text portions which means that the text portions of the text are randomly selected and are not predefined. They may however, be randomly selected from a predefined set of text portions. The predefined set of text portions may comprise, for example, only numbers and/or letters and/or only specific letters and/or only specific words.

The use of random text portions provides the advantage that in the verification of the identity, the voice utterance has to be created dynamically according to the provided text. This means that, for example, recording the voice of a person in order to conduct fraud is not possible here since it can not be anticipated which text will be generated.

It is furthermore preferred that the text comprises not more than three, four or five text portions. This is particularly useful when the text is rendered audible only. Since the person has to memorise the text portions and then repeat them by speaking them. This turns out to be unreliable for more than 3, 4 or 5 text portions.

In the case that the text is rendered readable, it is advantageous to have more than 4, 5, 6, 8 or 10 text portions. The more text portions are provided and the corresponding voice utterances are received, the more reliably the verification can be carried out.

In particular, for the case where the text does not have more than 3, 4 or 5 text portions, it is preferred to repeat the transmission of information to the person concerned with the desired voice utterance, at least 2, 3, 4 or more times.

The voice utterance may be received in different ways. One way is receiving a phone call. The person which was informed by the information action may phone the computing system. If the information action was carried out by conducting a phone call to this person, this one and the same phone call may be used to receive a voice utterance.

It is however also possible that the voice utterance is received by a data packet which includes a voice recording. In this case, there is no real time connection but the voice utterance is first recorded entirely and then sent as one or more data packets. This allows, for example, increased quality of the received voice utterance, since no real time data transmission has to be carried out in which sometimes information is lost irrecoverably. In the case of transmitting or receiving a data packet which includes a voice utterance, recording quality of the transmission can be much better since lost information can be repeated.

A time limit may be set such as 10 seconds, 30 seconds, 1 minute, 2 minutes, 5 minutes, 10 minutes, 20 minutes, 30 minutes, 45 minutes, 1 hour, 2 hours, 5, hours, 10 hours, or 24 hours within which the voice utterance has to be received after having performed the information action or after having transmitted information concerning a desired voice utterance. In the computing system a timer maybe installed to check for the timely receipt of the voice utterance. In other embodiments it may be preferred to define a certain time as a time limit.

Further it may be possible to try to repeat the performing of the information action in case that no voice utterance is received in time. The information action may be tried with the same or preferably with another telecommunications system. The number of attempts to inform the specific person of the event may be limited to a predefined number such as three, five, or ten.

Further after a predefined number of attempts or after lapse of a predefined time to inform the specific person of the event which have not succeeded in the sense that no voice utterance is received or that the verification failed the event may be disregarded, which means that no further attempts are made. If possible it is preferably attempted to inform the system which sent information of the event to the computing system that the act of informing the person of the event failed. Further it is possible to initiate other ways such as sending a registered letter in order to inform a person of an event in cases where the method of informing a person of an event failed.

In the verification step, preferably a statistical model of the voice of a person is used. This statistical model is preferably stored in the computing system. Statistical models allow for a relatively fast and accurate verification in particular in a computing system.

In the verification step the voice utterance is preferably evaluated/processed by taking into account a text which was generated and transmitted to the user. By knowing what is said the verification can more specifically identify a coincidence of the voice utterance with a stored voice model. In the verification it is therefore expected, that the person repeats the text transmitted to him. In this case the statistical model used may be a Hidden Markow Model which takes into account transition probabilities from one Gaussian Mixed Model to another during the pronunciation of a word, wherein each Gaussian Mixed Model refers to the pronunciation of one letter or individual sound of a word.

In typical password identification systems the password is purposely not transmitted in order to be repeated. A password has to be provided without this password being transmitted to the user for repetition during an identification process.

In the verification step the voice utterance may also be evaluated/processed not taking any information about an expected semantic content of the utterance into account. If for example the user is requested to provide some arbitrary text which he can make up himself the voice utterance is not related to any password, transmitted text or the like. Since the verification is preferably carried out based on biometric voice data the semantic content of the voice utterance may be of no importance and can be ignored.

Once the identity of the specific person is verified, the established telecommunication can be used to exchange further information. For example, a question may be generated and transmitted concerning agreement or disagreement to an action related to the event. If the event is, for example, related to a suspicious bank account movement, such a bank account movement can be authorized or cancelled. Also, further services which require verification of an identity can be conducted or offered afterwards. This may, e.g. be any online or telephone banking activity.

The computing system which carries out the method may be one single computer or a group of computers connected correspondingly. 1, 2, 3 or all steps of claim 1 or any other dependent claim may be carried out on one and the same computer or computing subsystem or on different computers or computing subsystems.

A further method comprises the steps of receiving information about an event, receiving a text and rendering the same for a person such that the text is readable or audible and transmitting a voice utterance of a person. This method may be e.g. carried out with a mobile telephone or any other telephone.

The invention furthermore relates to a computing system related to the previously mentioned method and to a computer-readable medium.

Preferred embodiments of the invention will be explained based on the enclosed Figures. These Figures are only provided in order to illustrate a preferred embodiment of the invention and should not be interpreted as restricting the scope of the invention.

Here it is shown in:

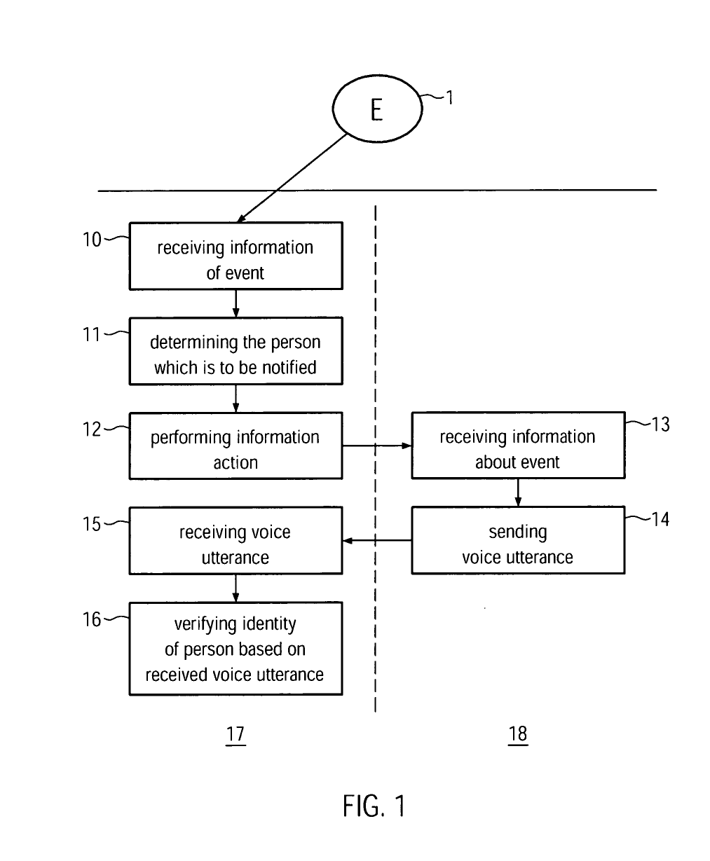

FIG. 1: an example of a method for informing a person of an event and of receiving information about an event,

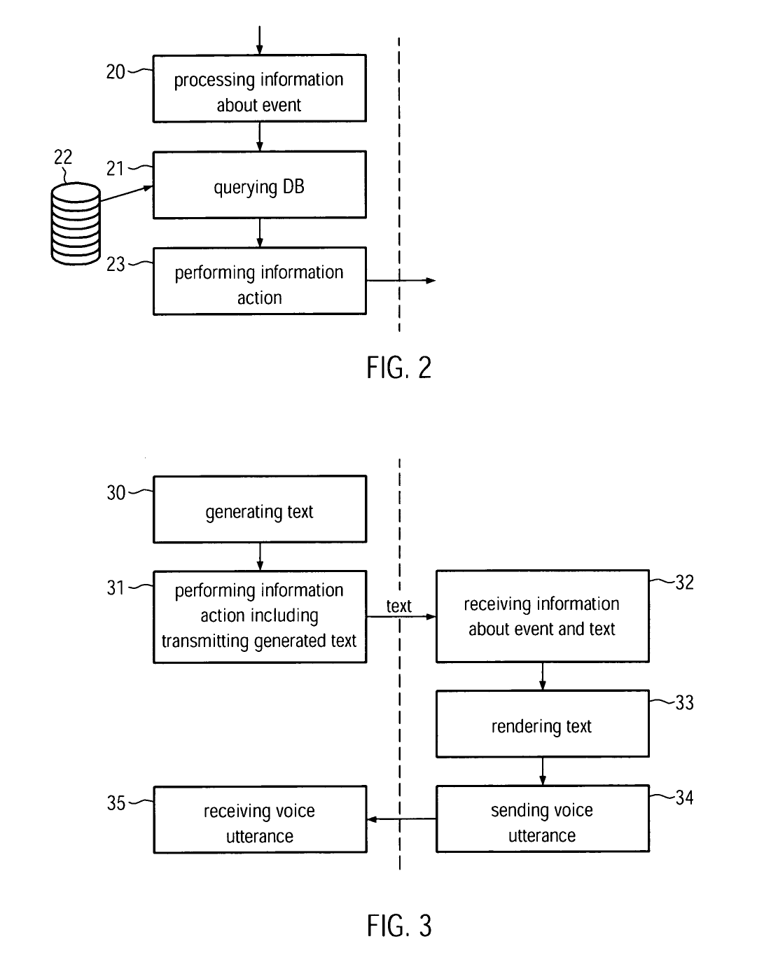

FIG. 2: a preferred embodiment of the method,

FIG. 3: a further preferred embodiment of the method,

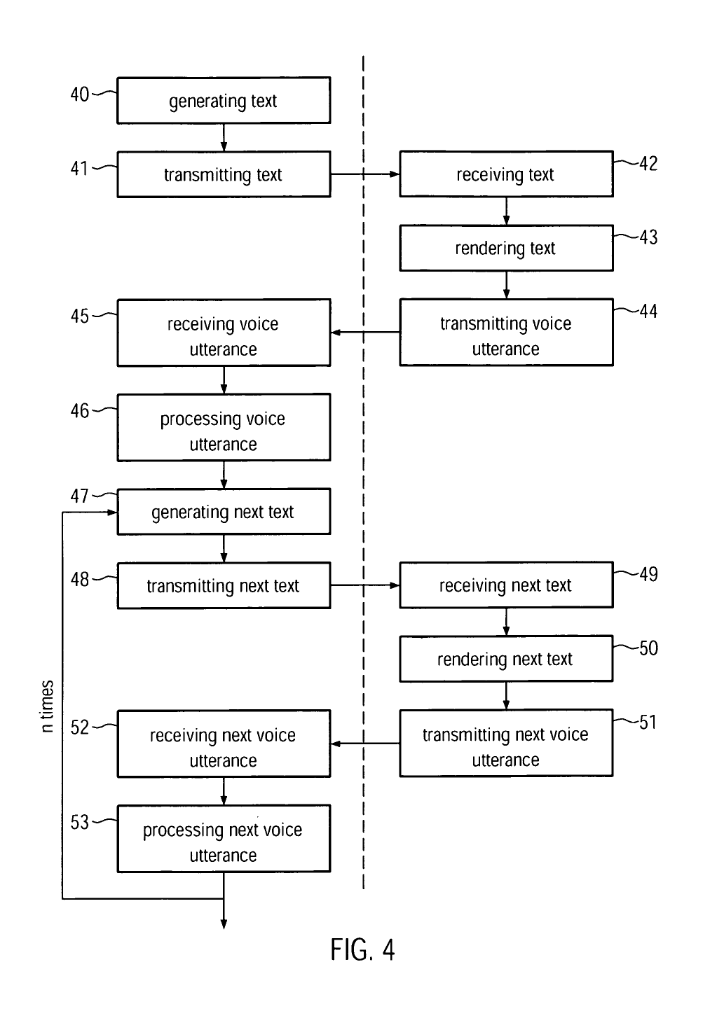

FIG. 4: another preferred embodiment of the method,

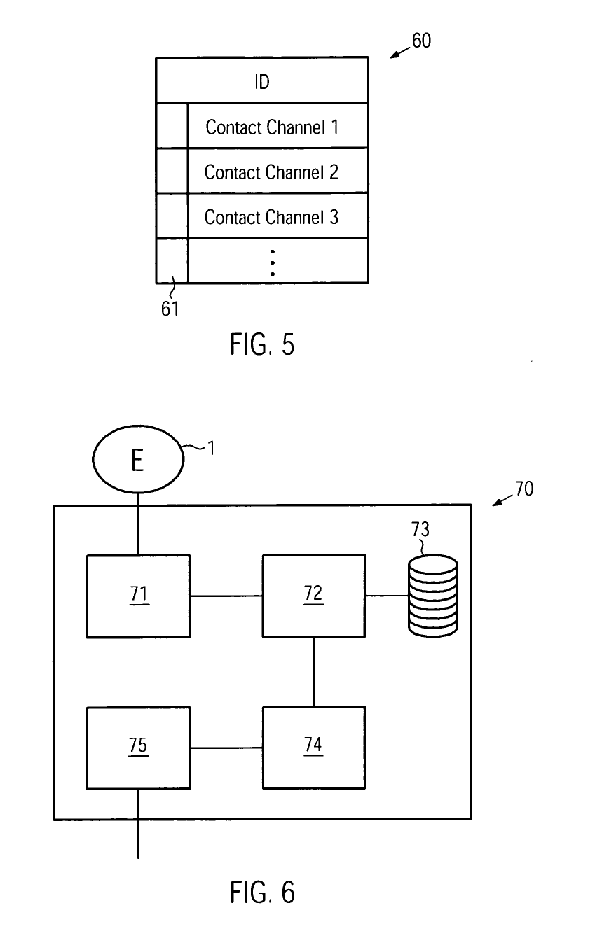

FIG. 5: a data structure, and

FIG. 6: components of a system according to a preferred embodiment.

FIG. 1 shows an event 1. This event is in general assumed to have taken place outside of a computing system which executes a method. The event may however, also be from the same computing system in case that this computing system provides further functionality which is not related to determining a person performing an information action, receiving a voice utterance or verifying the identify of a person. The further functionality may be e. g. a functionality of a banking system administrating bank accounts.

In FIG. 1 on the left side 17, the steps of a computing system, which may be a server, are shown and on the right side 18 the steps of a user side are shown.

The event may be any kind of event which has to be notified to a person. This includes, for example, suspicious bank account movements, any kind of notification of an administrative or legal nature or notifications of machine failure or emergency status of computer hardware/software or fabrication machines or the like. In the computing system, information about the event is received in step 10.

In step 11, from this information of the event, the person who is to be notified is determined. Depending on the specific nature of the event, there may be various ways in order to determine the person who is to be notified. In step 12, an information action is performed.

In this information action an attempt is made in order to inform the specific person of the event. In this step, usually a telecommunication system is used in order to perform this information action. As shown in step 13 which refers to the other end of the telecommunications connection, information about the event is received and a voice utterance is transmitted (see step 14). This voice utterance is transmitted to the computing system on the side 17 which receives the voice utterance in step 15. With the information about the specific person to be notified at hand, and the voice utterance of a person in step 16, it can be verified that the identity of the person to be notified is identical to that person of which the voice utterance was received.

In the computing system on the side 17, for example, a statistical model of the voice of the specific person who is to be notified may be stored and the voice utterance may be compared to such a statistical model. While this approach usually allows for a quick verification, other ways of verifying the identify based on the voice utterance may be performed in the computing system. For example, in the computing system on the side 17, another voice utterance of before, may be stored and the two voice utterances may be compared by a particular algorithm.

The semantic content of the voice utterance in this embodiment may not be taken into account and the voice utterance may refer to any semantic content.

In FIG. 2, a preferred embodiment is shown in which the step 11 of FIG. 1 is substituted by steps 20 and 21. Here, in step 20, the information received about the event is processed in order to generate or extract data which allows to query a database 22. This database then yields information which is required to perform the information action in step 23. The database 22 may, for example, provide a telephone number, a landline and/or mobile telephone, an IP number, a telefax number, an email address, a postal address or the like. With this contact information at hand, the information action may be performed in step 23.

FIG. 3 shows a preferred embodiment of carrying out step 15 of FIG. 1. In step 30, a text is generated. This may be a text randomly composed of text portions. In step 31, this text is transmitted together with the information of the event. The text may however also be transmitted in a separate step and/or by a separate other telecommunication system. In step 32, information about the event and the text is received. This may also be done by two separate steps. In step 33, the text is rendered which means that it is made visible or audible. In step 34, a voice utterance is sent. This voice utterance is generated by a person who e.g. reads the rendered text or has listened to the rendered text and repeats it. This voice utterance is received in step 35 by the side of the computing system.

In the following verification step the generated text is taken into account. The verification is based on the assumption that the voice utterance semantically corresponds to the transmitted text.

In FIG. 4 another preferred embodiment of the method is explained. In step 40, text is generated as in step 30 in FIG. 3. In step 41, this text is transmitted. This may be done together with the information of the event or separate thereof. This text is received in step 42 on the user side and rendered in step 43. In step 44 voice utterances are transmitted which are received on the computing system side in step 45.

In step 46, the received voice utterance is processed. This processing can, for example, be the verifying step 16 of FIG. 1. In step 47, the next text is generated which is transmitted in step 48 and received in step 49. This next text is rendered in step 50, the next voice utterance is transmitted in step 51 which is received in step 52. In step 53, the next voice utterance is processed which may be an additional verifying step 16 of FIG. 1. Steps 47 to 53 can be repeated n times, n being any number between, for example, 1 and 10. By generating different texts and receiving different voice utterances, the verification quality can be enhanced.

The steps of steps 47 to 53, however, may also relate to any further information exchanged between the computing system on the left side and the user on the right hand side.

In FIG. 5, a data structure 60 is shown which has different data entries. The first data entry refers to an ID of a specific person. This may be a name or number or any other ID which serves to uniquely identify a person. In this data structure 60, information about various contact channels 1 to 3 is stored. This information is provided in a specific order which is used to identify priorities of certain contact channels. Contact channel 1 which is the most preferred contact channel may be or refer to a landline telephone call while contact channel 2 refers to a mobile telephone number and contact channel 3 to a telephone connection to an office. Respective priority information of each contact channel may be stored in item 61 for each contact channel. Such a data structure may be used in the database mentioned beforehand.

In FIG. 6, a computing system is schematically shown. An event reception component 71 is capable of receiving information of event 1. This event reception component 71 is connected to a determining component 72 which is capable of determining a specific person which is to be notified of the event. Further, database 73, may be connected to the determining component 72 in order to provide specific data which allows connecting to the specific person. This database 73 or another database may be used to store data for verifying voices such as a statistical model.

Furthermore, a voice utterance reception component 75 is provided which is capable of receiving a voice utterance by a telecommunication system. A verification component 74 is provided which is capable of evaluating the received voice utterance and data of the person which is to be notified such as a statistical voice model. Each of the different components may be realized by hardware/software or combinations thereof.

1-17. (canceled)

18. A computer-based method of informing a person of an event, comprising the steps of:
(a) receiving, at a network-connected computer, electronic information pertaining to an event;
(b) using at least some of the electronic information to determine a specific person who is to be notified of the event;
(c) performing an action, via a telecommunications system, in order to inform the specific person of the event;
(d) receiving, via a network, a voice utterance of a person; and
(e) verifying that the identity of the person from whom a voice utterance was received coincides with that of the specific person to be notified of the event;
wherein the verification step is executed on a computer using at least voice biometric data derived from the received voice utterance.

19. The method of claim 18, wherein the step of determining the person who is to be notified comprises at least one of extracting information from the information pertaining to the event, and executing a query to a data subsystem based on the information received pertaining to the event.

20. The method of claim 19, wherein the step of determining the person who is to be notified comprises the step of determining at least one of a name, a personal identification number, and a unique data relating to a specific telecommunications system, such as a telephone number or an IP address.

21. The method of claim 19, wherein the action step comprises at least one of the following steps:
(a) performing a telephone call to a telephone number related to the person which is to be notified;
(b) sending a message by SMS and/or Email and/or Instant Messaging;
(c) sending a letter to a postal address related to the person which is to be notified;
(d) sending a fax to a fax number related to the person which is to be notified.

22. The method of claim 21, wherein the action step comprises performing various attempts in a predefined order of employing various telecommunications systems, wherein preferably:
(a) a phone call to a landline telephone is executed before a phone call to a mobile telephone is intended; and/or (b) a phone call is executed to a home or personal extension before being intended to an office extension.

23. The method of claim 19, further comprising the step of transmitting information to the person concerning a desired voice utterance which preferably comprises providing text having text portions such as words, numbers or letters or combinations thereof.

24. The method of claim 23, wherein:
(a) the text comprises random text portions; and/or
(b) the text comprises not more than three, four or five text portions; or the text comprises more than four, five, six, eight or ten text portions;

25. The method of claim 22, further comprising the step of transmitting information to the person concerning a desired voice utterance which preferably comprises providing text having text portions such as words, numbers or letters or combinations thereof

26. The method of claim 25, wherein:
(a) the text comprises random text portions; and/or
(b) the text comprises not more than three, four or five text portions; or
(c) the text comprises more than four, five, six, eight or ten text portions;

27. The method of claim 19, wherein in the step of verifying the identity a statistical voice model of the person which is determined to be notified of the event is used, wherein preferably this statistical voice model is stored in the computing system.

28. The method of claim 22, wherein in the step of verifying the identity a statistical voice model of the person which is determined to be notified of the event is used, wherein preferably this statistical voice model is stored in the computing system.

29. Method of receiving information about an event comprising the steps of:
(a) receiving information about an event;
(b) receiving a text and rendering the same for a person such that the text is readable or audible;
(c) transmitting a voice utterance of a person.

30. Computing system comprising:
(a) an event reception component for receiving information of an event;
(b) a determining component for determining a specific person which is to be notified of the event;
(c) a voice utterance reception component for receiving a voice utterance of a person;
(d) a verification component for verifying that the identity of the person coincides with that of the specific person based on the received voice utterance using biometric voice data.
